(19) United States
(12) Patent Application Publication
(10) Pub. No.: US 2011/0194585 A1
(43) Pub. Date: Aug. 11, 2011

(54) MULTIPLE OBJECT NON-CONTACT THERMOMETER

(76) Inventor: Abhishek Shrivastava, Maimi, FL (US)

(21) Appl. No.: 12/793,997

(22) Filed: Jun. 4, 2010

Related U.S. Application Data
(60) Provisional application No. 61/302,880, filed on Feb. 9, 2010.

(51) Int. Cl. G01K 1/08; G01K 1/02

(52) U.S. Cl. 374/120; 374/208; 374/E01.002; 374/E01.011

(57) ABSTRACT

A thermometer is disclosed, comprising a handle, a sensor, an interface, a speaker, a memory, and a display. The sensor is configured to detect the surface temperature of an object without contacting the surface. In some embodiments, the interface includes a mode button to select from a plurality of modes of operation including a surface mode, a human body mode, an animal body mode, and an ambient mode. In some embodiments, temperature readings are stored in the memory for later retrieval and display. A method of generating a temperature reading is also disclosed.

### CROSS-REFERENCE TO RELATED APPLICATIONS

This application claims the benefit of U.S. Provisional Application No. 61/302,880, titled MULTIPLE OBJECT NON-CONTACT THERMOMETER WITH WIRELESS COMMUNICATION AND AUTOMATIC CALIBRATION, filed on Feb. 9, 2010, which is hereby incorporated by reference in its entirety.

### BACKGROUND

The present application relates generally to the field of thermometers and more specifically to non-contact thermometers for detecting the temperature of multiple objects.

For many years, elevated body temperature has been recognized as an indicator of illness in both humans and animals. Many technologies have been developed through the years to provide timely indications of body temperature for purposes of diagnosing illness. More recently, thermopile-based thermometers have been developed to provide contact readings of body temperature. These thermopile-based thermometers generally rely on physical contact between the thermometer and the patient to ensure accurate core body temperature readings. Unfortunately, contacting the thermometer to the body of a sick patient presents several problems including possible spread of illness. Thus, a device for non-contact core body temperature readings is desired.

### SUMMARY

Thermometers for detecting body temperature generally only provide body temperature readings and only through a visual, numeric display. However, people often find themselves in situations where it would be helpful to know temperatures other than body temperature and/or when it is difficult to see/read a visual display. For example, a child care provider may want to know a child's temperature one minute and the next minute want to know the temperature of the child's bottle or bath water or the temperature of the room children are napping in. Accordingly, it would be helpful to have a single thermometer that can report body temperature and the temperature of a surface, as well as ambient temperature, and that can provide temperature readings in other than visual, numeric format.

Although much research and development has been done in the area of human body temperature measurement, significantly less development has been done on taking the temperature of animals. Pet owners may find it useful to take their pet's temperature when they suspect the pet is sick, for example. Traditionally, pet temperature measurement is done with a rectal thermometer which can be an uncomfortable process for both the pet and the owner, and in some cases a nearly impossible task depending on the size of the animal. Additionally, rectal temperature measurements can be harmful to some pets, such as birds. Traditional contact thermometers have not been readily adaptable to this situation because target body temperature varies from species to species and even breed to breed. Further, the locations for temperature measurements applicable to humans may not provide accurate temperature measurements for animals and the calculations applicable to determining core body temperatures in humans do not correlate directly with those for animals. Consequently, a need exists for a thermometer that can provide accurate body temperatures for animals without using invasive techniques such as rectal measurements.

The above-mentioned drawbacks associated with existing thermometers are addressed by embodiments of the present application, which will be understood by reading and studying the following specification.

One embodiment of the present application is a thermometer including a handle, a sensor disposed at an end of the handle, an interface and a speaker on the handle, a memory, and a display. The sensor can detect a surface temperature of an object external to the thermometer without contacting the object. The memory can store previous temperature readings for later retrieval and display.

Another embodiment of the present application is a method of generating a temperature reading. The method includes receiving an actuation signal on a thermometer in proximity to a surface of an object, detecting a sensor temperature, an object temperature, and an ambient temperature, determining a mode of operation of the thermometer, and displaying an output temperature dependent on the mode of operation and responsive to at least one of the sensor temperature, the object temperature, and the ambient temperature.

These and other embodiments of the present application will be discussed more fully in the detailed description. The features, functions, and advantages can be achieved independently in various embodiments of the present application, or may be combined in yet other embodiments.

### BRIEF DESCRIPTION OF THE DRAWINGS

FIG. 1 shows a block diagram of a non-contact thermometer according to some embodiments of the present application.

FIG. 2 shows a perspective view of a non-contact thermometer according to some embodiments of the present application.

FIG. 3 shows a plan view of a non-contact thermometer according to some embodiments of the present application.

FIGS. 4a and 4b show plan and cross-section views, respectively, of a display for a non-contact thermometer according to some embodiments of the present application.

FIG. 5 shows a sensor for a non-contact thermometer according to some embodiments of the present application.

FIG. 6 shows a block diagram of the controls portion of a non-contact thermometer according to some embodiments of the present application.

FIG. 7 shows a functional flowchart for a non-contact thermometer according to some embodiments of the present application.

Like reference numbers and designations in the various drawings indicate like elements.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

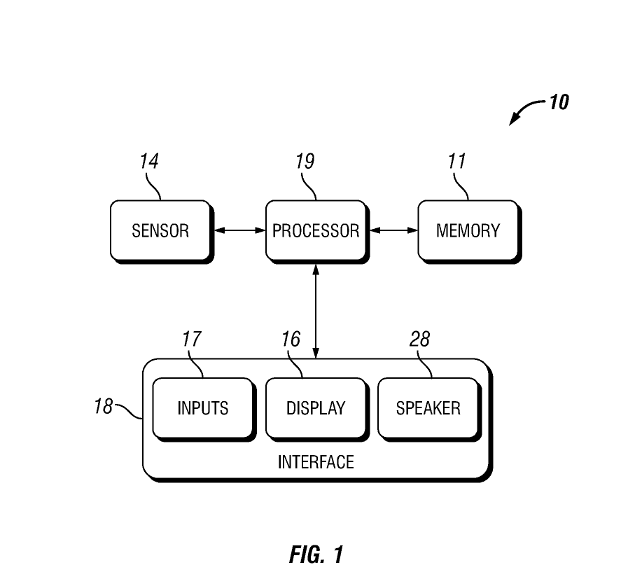

FIG. 1 shows a block diagram of a non-contact thermometer according to some embodiments of the present application. As shown in FIG. 1, a non-contact thermometer 10 includes a memory 11, a sensor 14, a processor 19, and an interface 18. The interface 18 can include inputs 17, a display 16, and a speaker 28. The processor 19 can communicate with the sensor 14, the memory 11, and/or the interface 18 to provide temperature readings and other information to a user, as further described below. As an example, the processor 19 may receive a signal from the interface 18 indicating a measurement should be taken. The processor 19 can then direct the sensor 14 to take a reading and receive signals from the sensor 14. The processor 19 can convert the signals, which may be in the form of voltage signals, into a temperature value, which can then be displayed by the display 16, output through the speaker 28, and/or stored in the memory 11. Further, the processor 19 may refer to data stored in the memory 11 to convert the signals into the temperature value.

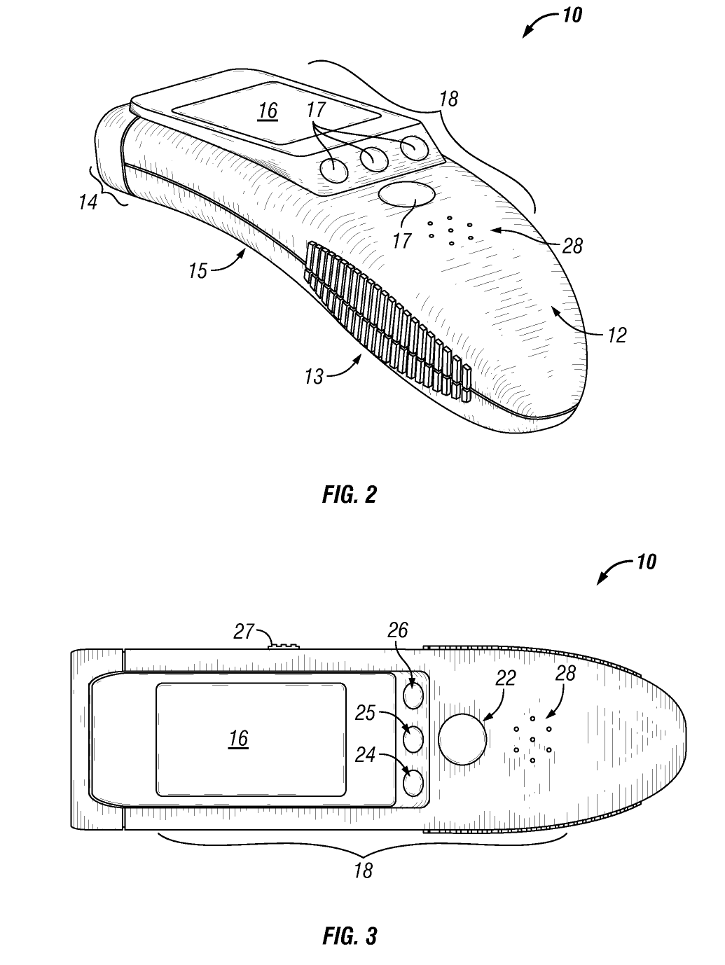

FIG. 2 shows a perspective view of a non-contact thermometer according to some embodiments of the present application. As shown in FIG. 2, the non-contact thermometer 10 includes a handle portion 12, the sensor 14, and the interface 18. The interface 18 can include the inputs 17, the display 16, and the speaker 28. The handle portion 12 may include grips 13 to aid in holding the non-contact thermometer 10 during use. The grips 13 can be made from any material, such as rubber or plastic that aids in holding the non-contact thermometer 10. As an example, the grips 13 can be molded plastic that is incorporated into the handle portion 12. The non-contact thermometer 10 can detect and display the temperature of various objects without contacting the objects.

According to some embodiments, the handle portion 12 includes an offset 15 to allow a user to hold the non-contact thermometer 10 in one hand and direct the sensor 14 toward an object to be measured while simultaneously manipulating the interface 18. The offset 15 may be about 45 degrees.

The non-contact thermometer 10 may have several modes of operation. In a first mode, referred to herein as body mode, the non-contact thermometer 10 can detect and display the core body temperature of a person or animal. In the body mode, the non-contact thermometer 10 may take a direct reading from the body and then adjust the direct reading so as to display the core body temperature for the person or animal. The core body temperature can correspond to any of an oral temperature, a rectal temperature, an axillary temperature, and a core temperature. In other words, different core temperature curves can be used to calculate corresponding oral, rectal, axillary and core temperatures from the direct reading.

In a second mode, referred to herein as surface mode, the non-contact thermometer 10 can detect and display the temperature of a surface. In the surface mode, the non-contact thermometer 10 may not adjust the direct reading and may display the reading directly. In a third mode, referred to herein as ambient mode, the non-contact thermometer 10 can detect and display the ambient temperature around the non-contact thermometer 10.

FIG. 3 shows a plan view of a non-contact thermometer according to some embodiments of the present application. As shown in FIG. 3, the interface 18 of the non-contact thermometer 10 includes the display 16, an actuator 22, a mode button 24, a scale selector button 25, a memory button 26, a language selector 27, and the speaker 28. The actuator 22 can cause the non-contact thermometer 10 to take a temperature reading when pressed by the user. The actuator 22 can also cause a visible spot to be emitted from the non-contact thermometer 10 as an indication of the target area for temperature measurement, as further described below. Additionally, a separate target finder button in the interface 18 can cause a visible spot to be emitted from the non-contact thermometer 10 as an indication of the target area for temperature measurement. When either the actuator 22 or the target finder button is actuated, the non-contact thermometer 10 can take a measurement of the distance between the thermometer and the surface being measured. This distance can be displayed in the display 16. Also, a separate distance button in the interface 18 can be used to actuate the distance measurement.

The mode button 24 can be used to select the mode of operation for the non-contact thermometer 10. By repeatedly pressing the mode button 24, a user can select between various modes of operation of the non-contact thermometer 10, including body/person mode, body/animal mode, surface mode, ambient mode, and any other modes of operation. When the mode button 24 is pressed, the display 16 may indicate which mode of operation is selected. Further, when the mode button 24 is pressed, the speaker 28 may emit an indication of what mode is selected. Combinational modes can also be selected such that a single press of the actuator 22 causes the non-contact thermometer 10 to sequentially (or in parallel) display multiple temperatures for a single reading. For example, when the non-contact thermometer 10 is in a body/ambient combinational mode, a single press of the actuator 22 can cause the non-contact thermometer to first output the body temperature and then output the ambient temperature. A person of ordinary skill in the art will recognize that other combinations are possible and fall within the spirit and scope of the present invention.

The scale selector button 25 can cause the non-contact thermometer 10 to switch between different temperature scales. For example, pressing the scale selector button 25 may cause the non-contact thermometer 10 to switch from the Celsius scale to the Fahrenheit scale. Repeatedly pressing the scale selector button 25 may cause the non-contact thermometer 10 to cycle repeatedly through the available scales, which may include Celsius, Fahrenheit, Kelvin, and the like.

The memory button 26 can cause the non-contact thermometer 10 to display one or more prior readings. For example, pressing the memory button 26 once may cause the non-contact thermometer 10 to display the most recent reading, pressing the memory button 26 twice may cause the non-contact thermometer 10 to display the reading immediately before the most recent reading, and so on. The type of reading (e.g., body, surface, or ambient) may also be stored with each prior reading and be output with the prior reading when the memory button 26 is pressed. The memory 11 in the non-contact thermometer 10 may be configured to store a specific number of prior readings and repeatedly pressing the memory button 26 can cause the thermometer to display all of the stored readings in sequence and loop back to the beginning when the final stored reading is displayed. As an example, the memory in the non-contact thermometer 10 may store approximately 32 prior readings. Additionally, when the non-contact thermometer 10 includes a time/date function, the prior readings may be stored with a corresponding time or date such that pressing the memory button 26 causes the thermometer to output both the prior reading and the associated time/date. Moreover, the prior readings may be stored along with data indicating a subject identification corresponding to the reading. Consequently, pressing the memory button 26 can cause the thermometer to output both the prior reading and the associated subject identification, which may identify a specific person or animal or a type of animal.

The speaker 28 can emit audible sounds in response to various events associated with the non-contact thermometer 10. For example, the speaker 28 can emit a beep when any button on the non-contact thermometer 10 is pressed, when the actuator 22 is pressed, when there is an error, and/or upon completion of a reading. Additionally, the speaker 28 can emit words in one of multiple languages in response to various events. For example, upon completion of a reading, the speaker 28 can emit words indicating the mode of operation and the reading, among other things. Moreover, when any button on the non-contact thermometer 10 is pressed, the speaker 28 can emit words indicating what button was pressed or indicating the result of the button-press operation. For example, when the mode button 24 is pressed to select the surface mode, the speaker 28 may emit words such as “mode,” “surface mode,” or “surface mode selected.”

The language selector 27 can cause the non-contact thermometer 10 to select between two or more language modes, thereby controlling the language of words emitted from the speaker 28. For example, pressing the language selector 27 can cause the non-contact thermometer 10 to change from an English mode to a French mode or to turn the word function off. Additionally, repeatedly pressing the language selector 27 can cause the non-contact thermometer 10 to cycle among various available language settings (or no language at all) including, for example, English, French, Spanish, Off, etc. Each language available in the non-contact thermometer 10 may include a set of pre-recorded messages to be output through the speaker in response to specific events associated with the thermometer (such as taking a reading). Accordingly, selecting of a language with the language selector 27 can include selecting a set of pre-recorded messages among a plurality of sets of pre-recorded messages.

Pressing at least two of the mode button 24, the scale selector button 25, the memory button 26, and the language selector 27 can cause the non-contact thermometer 10 to enter a calibration mode. When in calibration mode, the user can calibrate the readings of the non-contact thermometer 10 to match readings from a separate source or calibration standard.

Although the interface 18 has been described above with respect to certain buttons and features, a person of ordinary skill in the art will appreciate that many other buttons, features, and configurations are possible and fall within the spirit and scope of the invention. For example, the non-contact thermometer 10 could include additional buttons for such features as setting the time and date or selecting the subject and/or the buttons described above could have multiple functions depending on the number of times the buttons are pressed, the combination of buttons pressed, and/or the duration for which a button is pressed.

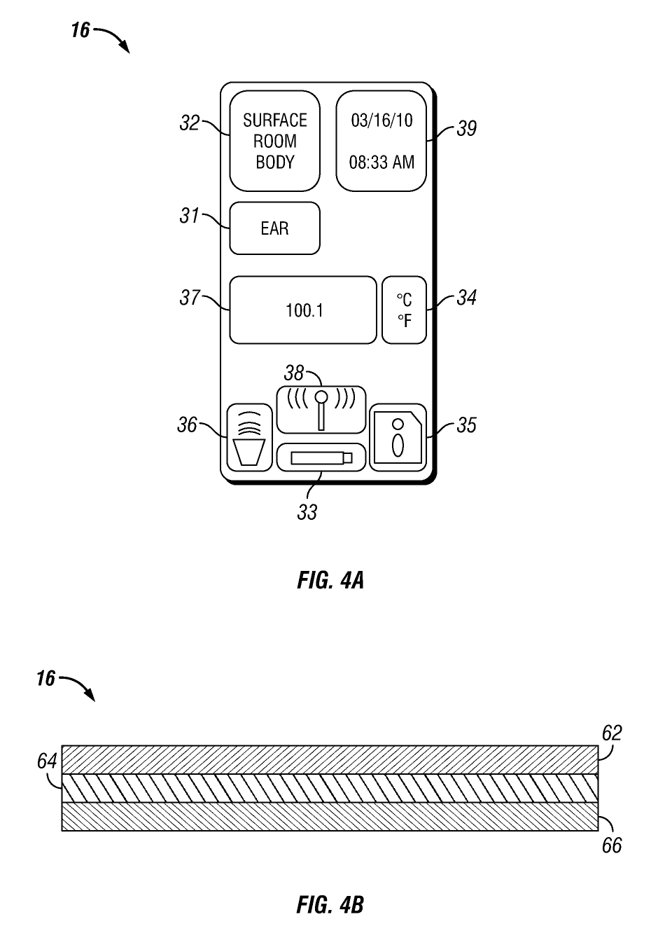

FIGS. 4a and 4b show a plan view and a cross-section view, respectively, of a display for a non-contact thermometer according to some embodiments of the present application. As shown in FIG. 4a, the display 16 includes a mode indicator 32, a battery indicator 33, a scale indicator 34, a memory indicator 35, a speaker indicator 36, and a temperature indicator 37. The display 16 may comprise an LCD (liquid-crystal display) panel with each of the mode indicator 32, the battery indicator 33, the scale indicator 34, the memory indicator 35, the speaker indicator 36, and the temperature indicator 37 occupying a portion of the LCD panel. The mode indicator 32 can display the mode of operation of the non-contact thermometer 10, for example, body mode, surface mode, and ambient mode. Similarly, the scale indicator 34 can indicate the current scale for which temperature readings are being displayed in the temperature indicator 37.

The battery indicator 33 can display the status of the battery in the non-contact thermometer 10. For example, when the battery is low, the battery indicator 33 may flash a picture of a battery or show a picture of a battery, among other types of indications. Moreover, the battery indicator 33 may provide a continuous indication of battery status by continually, or periodically, displaying a picture of a battery with a sliding scale superimposed on the picture to indicate battery life. Additionally, words such as “Low,” “Good,” “High,” etc. may be used to indicate the status of the battery in the battery indicator 33.

The memory indicator 35 may indicate when the memory inside of the non-contact thermometer 10 is being accessed to display historical readings. For example, when the user presses the memory button 26 to access a stored reading, the memory indicator 35 may show a graphic to indicate that the memory is being accessed. Similarly, the speaker indicator 36 may display a graphic when a language is selected and/or show a different graphic when the language function is turned off.

The temperature indicator 37 can display the output temperature from the most recent temperature sensing operation. Additionally, the temperature indicator 37 can display historical temperature sensing data when the memory button 26 is pressed. Moreover, the temperature indicator 37 can display other data associated with the non-contact thermometer 10 such as the language that is currently selected, error codes, calibration codes, and the like. The temperature indicator 37 may also display multiple temperature readings simultaneously. In other words, the temperature indicator 37 may display, for example, both a body mode reading and a surface mode reading at the same time. Preferably, the temperature indicator shows four digits such that temperatures in the range of about 50 degrees Fahrenheit to about 110 degrees Fahrenheit can be displayed, but more or less digits may be displayed depending upon the accuracy of the non-contact thermometer 10 and other factors. The temperature indicator 37 can also display a distance measurement showing the distance between the object being measured and the thermometer. Additionally, the distance measurement can be displayed in another portion of the display 16.

As shown in FIG. 4b, the display 16 may include a transparent top panel 62, a light modification layer 64, and a backlight 66. The top panel 62 can protect the other components of the display 16 disposed underneath. The light modification layer 64 can modify the light coming from the backlight 66 such that only certain areas of the display 16 emit light at a given time. Also, the light modification layer 64 can modify the color of the light coming from the backlight 66. According to some embodiments, the light modification layer 64 can comprise liquid crystal material. The backlight 66 emits light using, as examples, light-emitting diodes (LEDs), incandescent lights, fluorescent lights, or the like. The backlight 66 may emit light in one of several colors or it may emit white light. Additionally, the backlight 66 may change color in response to the status of the non-contact thermometer 10 or events associated with the thermometer. For example, the color of the backlight 66 may be green when a body temperature reading is within a pre-defined normal range and the color may be red when the body temperature range is outside the pre-defined normal range. Also, the color of the backlight 66 can be red when the non-contact thermometer 10 is initializing or between measurements and then the color can change to green when the non-contact thermometer 10 is ready to take a reading. A person of ordinary skill in the art will recognize that other colors, ranges, and conditions are possible and fall within the spirit and scope of the invention.

According to some embodiments, the display 16 may include a time/date indicator 39. The time/date indicator 39 can display the current time and date or display the time and date associated with a prior temperature reading when the memory button 26 is pressed. The display 16 may also include a location indicator 31. The location indicator 31 can indicate the preferred location for measurement when in the body mode. The indicated location may correspond to the particular core temperature curve that is being applied to calculate the core temperature of the person/animal being measured, as further described below. The location indicator 31 can also display an indication of the subject that corresponds to the currently selected curve.

According to some embodiments, the display 16 may include a connection indicator 38. The connection indicator 38 can display an indication of whether the non-contact thermometer 10 is connected to an external network or device through, for example, a USB connection or a BLUETOOTH or other wireless connection. The connection indicator 38 can display different images depending on the type of connection that is currently active on the non-contact thermometer 10.

The display 16 can be provided in various sizes and shapes. According to some embodiments, the display 16 can be approximately 3 cm by 2 cm. In prior art thermometers, small displays are typically used to keep costs down and because only a small display is needed to show the limited information provided (the temperature reading). However, the non-contact thermometer 10 provides a much larger display 16 such that much more information can be provided to the user. For example, the display 16 on the non-contact thermometer 10 can simultaneously show the temperature reading, the mode of operation, the temperature scale, and the battery life, among other things. Further, when using a backlight 66 having multiple colors, the large display 16 can provide the user with a large visual indication of information associated with the most recent reading, as described above.

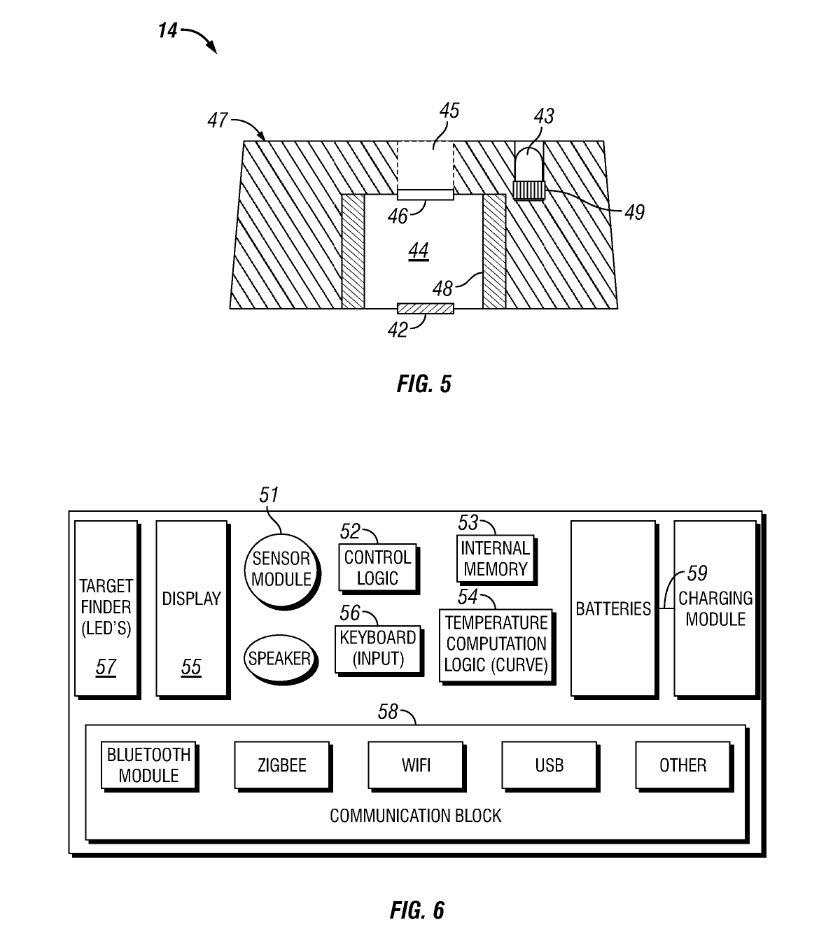

FIG. 5 shows a cross-sectional view of a sensor for a non-contact thermometer according to some embodiments of the present application. As shown in FIG. 5, the sensor 14 includes a detector 42, a chamber 44, a window 46, a housing 47, and a heat sink 48. The detector 42 may comprise a thermopile or transducer. For example, in some embodiments, detector 42 comprises a semiconductor thermopile. The detector 42 may detect infrared radiation and output a voltage signal corresponding to the detected radiation. The voltage signal can then be converted into a temperature value. The window 46 is disposed over an opening in the chamber 44 through which infrared radiation reaches the detector 42 from outside of the non-contact thermometer 10. Accordingly, the window 46 can be substantially transparent to infrared radiation in the wavelength range from about 8 μm to about 14 μm.

The heat sink 48 provides a large thermal mass to minimize temperature fluctuations in the chamber 44. Accordingly, the heat sink 48 may comprise a metal such as aluminum, brass, etc., and may have a relatively large mass compared to the chamber 44 and other elements of the sensor 14. The heat sink 48 may substantially surround the sidewalls of the chamber 44. The housing 47 can comprise plastic or other thermally-insulative material and can thermally separate the heat sink 48 from the environment around the non-contact thermometer 10, thereby helping to minimize temperature fluctuations in the chamber 44.

The housing 47 may also include a recess 45 such that the window 46 is set back from the front surface of the non-contact thermometer 10, thereby minimizing damage to and debris collection on the window 46. The sensor 14 may also include a target indicator 43 to indicate the approximate location on a target object at which the temperature is being sensed. The target indicator 43 may comprise, for example, a laser pointer that projects a red spot near the point of measurement when the actuator 22 is pressed. The target indicator 43 may also include a distance unit 49 for determining the distance between the non-contact thermometer 10 and the surface being measured.

FIG. 6 shows a block diagram of the controls portion of a non-contact thermometer according to some embodiments of the present application. Referring to FIG. 6, a non-contact thermometer includes a sensor module 51, control logic module 52, internal memory 53, a temperature computation module 54, a display module 55, and an input module 56. The non-contact thermometer can also include a target indicator module 57, a communication block 58, and a power module 59. The sensor module 51 includes the control circuitry and connections to interface with the sensor 14. The internal memory 53 can comprise any type of memory including flash memory, static random-access memory, dynamic random-access memory, magnetic media memory, read-only memory, an EEPROM, and/or any combination of memories. The internal memory 53 can be used to store intermediate computational values, long-term computational data, calibration data, core temperature curves, and past temperature readings, among other things.

The temperature computation module 54 can convert direct readings (such as voltage signals) from the sensor 14 into body temperatures equivalent to oral, rectal, axillary and core temperatures as well as an absolute temperature reading to be displayed to a user. In order to make these conversions, the temperature computational module 54 may use one or more core temperature curves. The core temperature curves can be specific to a particular type of animal, to a particular location of measurement on the animal's body, and/or a particular breed of animal. Similarly, the core temperature curves can be specific to a particular location of measurement on a person's body. The selection of the core temperature curve applicable to a particular measurement can be done by the user on a per-measurement basis through the interface 18.

As an example, a user may wish to take a core body temperature measurement on a dog. Thus, the user might select a core temperature curve corresponding to a terrier dog with the measurement taken on the dog's gums. Once the reading is taken on the dog's gums, the temperature computational module 54 can use the appropriate core temperature curve to convert the actual reading at the dog's gums to a core body temperature reading for the dog. Core temperature curves can be provided for any type of animal including pets, farm animals, and animals in the wild. Core temperature curves can also be provided for measurements at several locations on an animal, including the inner ear, the gums, the perianal area, and the abdomen. The preferred measurement location (e.g., ear, gums, etc.) as well as the type of animal (e.g., bird, dog, terrier, etc.) for the particular core temperature curve being applied to a temperature measurement may be shown on the display 16 of the non-contact thermometer 10.

The display module 55 provides the drive and logic circuitry to operate the display 16. For example, when the display 16 comprises an LCD display, the display module 55 may provide circuitry for addressing and controlling the individual segments of the LCD display. Similarly, the input module 56 provides the drive and logic circuitry to operate the interface 18. For example, the input module 56 can provide circuitry to detect when one of the buttons on the interface 18 is pressed, as well as indicating which button is pressed, how long the button is pressed, and the like.

The control logic module 52 can control the overall functionality of the non-contact thermometer 10. For example, the control logic module 52 can interface with the sensor module 51, the internal memory 53, the temperature computation module 54, the display module 55, and the input module 56 to obtain readings, perform computations on the readings, display readings and other information, store information, and accept input from the user. The control logic module 52 can comprise any type of general purpose processor, including for example, an application-specific integrated circuit (ASIC).

The non-contact thermometer may also include a communication block 58 to provide wired and/or wireless communications with external networks or devices. According to some embodiments, the non-contact thermometer can download core temperature curves and optimum measuring distance through the communication block 58 and/or upload readings through the communication block 58. The non-contact thermometer may also include a target indicator module 57. The target indicator module can provide the drive and control circuitry for the target indicator 43, when provided. The non-contact thermometer may also include a power module 59. The power module may include a power source and a charging module. The power source can comprise standard disposable batteries, rechargeable batteries, capacitive storage, and the like. The charging module can include a power jack for connection of a power cord to a wall outlet and can allow rechargeable batteries within the non-contact thermometer to be recharged without removal from the thermometer.

Although described above as individual modules, a person of ordinary skill in the art will recognize that one or more of the sensor module 51, control logic module 52, internal memory 53, temperature computation module 54, display module 55, input module 56, target indicator module 57, communication block 58, and power module 59 can be incorporated into a single processor such that the individual modules are not discrete components on a circuit board, but are instead functional blocks within the processor. Moreover, the functions described above with respect to individual modules may be embodied as computer-readable code that, when executed by a processor, causes the non-contact thermometer to perform the described functions.

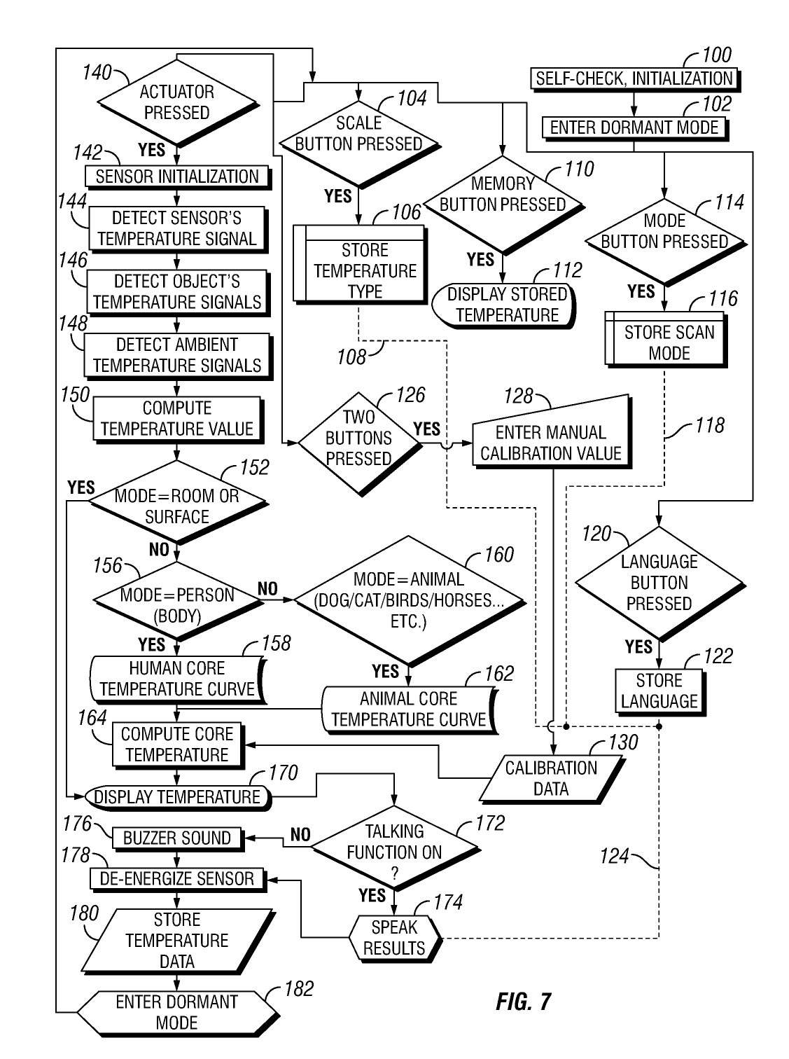

FIG. 7 shows a functional flowchart of a non-contact thermometer according to some embodiments of the present application. As shown in FIG. 7, the operation of a non-contact thermometer begins at Block 100 by performing a self-check and display initialization. At Block 102, the non-contact thermometer enters dormant mode and the display is turned off to conserve battery life. The non-contact thermometer may include a timer and entering dormant mode may be dictated by the expiration of the timer. As an example, the timer may have a period of approximately five seconds. While in dormant mode, the non-contact thermometer monitors for any buttons on the interface to be pressed.

When the scale selector button is pressed at Block 104, the non-contact thermometer cycles between the various available temperature scales, as described above. Each time the scale selector button is pressed, the non-contact thermometer stores an indicator for the selected temperature scale in memory at Block 106. As shown by dotted path 108, the non-contact thermometer may speak the results of a scale selecting operation each time the scale selector button is pressed.

When the memory button is pressed at Block 110, the most recent temperature reading is displayed at Block 112. As described above, repeatedly pressing the memory button at Block 110 causes the non-contact thermometer to display earlier temperature readings at Block 112.

When the mode button is pressed at Block 114, the non-contact thermometer cycles between the various available modes, as described above. Each time the mode button is pressed, the non-contact thermometer stores an indicator for the selected mode in memory at Block 116. As shown by dotted path 118, the non-contact thermometer may speak the results of a mode selecting operation each time the mode button is pressed.

When the language selector button is pressed at Block 120, the non-contact thermometer cycles between the various available languages, as described above. Each time the language selector button is pressed, the non-contact thermometer stores an indicator for the selected language in memory at Block 122. As shown by dotted path 124, the non-contact thermometer may speak the results of a language selecting operation each time the language selector button is pressed. Speaking the results of the language selecting operation may include speaking the results in the selected language or speaking the results in a particular default language, such as English.

When two buttons (for example, the scale selector button and the mode button) are pressed substantially simultaneously at Block 126, the non-contact thermometer enters calibration mode and requests a manual calibration value from the user at Block 128. The manual calibration value entered by the user is then stored in memory at Block 130. The manual calibration value can then be used to calculate the core temperature at Block 164.

When the actuator is pressed at Block 140, the sensor circuit is initialized at Block 142. Initializing the sensor circuit may include applying the proper voltage to the detector and verifying the stability of the detector measurements, among other things. At Block 144, a sensor temperature signal (such as a voltage signal) is obtained from the detector. An object temperature signal is obtained from the detector at Block 146 and, at Block 148, an ambient temperature signal is obtained from the detector. Using one or more of these three signals, a temperature value is computed at Block 150. For example, the non-contact thermometer may use the sensor temperature signal and the object temperature signal to calculate the surface temperature of the object as the temperature value.

At Block 152, a determination is made as to whether the non-contact thermometer is in ambient/room or surface mode. If a ‘Yes’ result is obtained from the determination, the non-contact thermometer displays either the object temperature or the ambient temperature, as appropriate, at Block 170. If a ‘No’ result is obtained at Block 152, a determination is made as to whether the non-contact thermometer is in a body/person mode at Block 156. At Block 158, if the non-contact thermometer is in a body/person mode, a human core temperature curve is applied to the computed temperature value of Block 150 and a core temperature is computed at Block 164.

If a ‘No’ result is obtained at Block 156, a determination is made as to whether the non-contact thermometer is in a body/animal mode at Block 160. At Block 162, if the non-contact thermometer is in a body/animal mode, an animal core temperature curve is applied to the computed temperature value of Block 150 and a core temperature is computed at Block 164. If a ‘No’ result is obtained at Block 160, the object temperature is displayed at Block 170 as if the surface mode were selected.

At Block 170, the core temperature computed at Block 164 (or the surface or ambient temperature from Block 152) is displayed. Further, a determination is made at Block 172 as to whether a particular language is selected or the talking function is set to off. If a language is selected, the non-contact thermometer speaks the results of the temperature reading in the selected language at Block 174. If the talking function is set to off, the speaker emits a buzzer sound at Block 176.

At Block 178, the sensor circuit is de-energized and at Block 180, the displayed temperature is stored into memory. The non-contact thermometer enters dormant mode at Block 182, preferably responsive to the expiration of a timer, as described above. Although a basic operational flowchart for a non-contact thermometer has been described above, a person of ordinary skill in the art will recognize that many other optional paths and operations are possible and fall within the spirit and scope of the invention.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A thermometer comprising:
a handle having a first end and a second end;
a sensor disposed at the first end of the handle and configured to detect a surface temperature of an object external to the thermometer;
an interface disposed on the handle, the interface including an actuator;
a speaker disposed in the handle;
a memory configured to store a plurality of stored temperature readings; and
a display disposed on the handle, wherein the display is configured to display at least one of the surface temperature of the object, an ambient temperature, and a core body temperature of the object.

2. The thermometer of claim 1, wherein the second end of the handle comprises grips and wherein the handle includes an offset.

3. The thermometer of claim 1, wherein the sensor is configured to detect the surface temperature of the object without contacting the object.

4. The thermometer of claim 1, wherein the interface further comprises at least one of a mode button, a scale selector button, a memory button, a distance button, a target finder button, and a language selector.

5. The thermometer of claim 4, wherein the mode button is configured to select at least one of a plurality of modes of operation of the thermometer.

6. The thermometer of claim 5, wherein the plurality of modes of operation includes at least one of a surface mode, a human body mode, an animal body mode, and an ambient mode.

7. The thermometer of claim 4, wherein the scale selector button is configured to select at least one of a plurality of temperature scales including Fahrenheit and Celsius scales.

8. The thermometer of claim 4, wherein the memory button is configured to select at least one of the plurality of stored temperature readings in the memory and wherein the thermometer is configured to display the stored temperature reading that is selected.

9. The thermometer of claim 4, wherein the language selector is configured to select at least one of a plurality of languages and wherein the thermometer is configured to output words through the speaker in the language that is selected.

10. The thermometer of claim 9, wherein each language in the plurality of languages includes a message set comprising a plurality of pre-recorded messages.

11. The thermometer of claim 1, wherein the display comprises at least one of a mode indicator, a subject indicator, a distance indicator, a time/date indicator, a battery indicator, a scale indicator, a memory indicator, a speaker indicator, a connection indicator, and a temperature indicator.

12. The thermometer of claim 1, wherein the display comprises a backlight and wherein the display is configured to change color.

13. The thermometer of claim 1, wherein the sensor comprises:
a housing;
a chamber disposed in the housing;
a detector disposed at a first end of the chamber;
a window disposed at a second end of the chamber so as to cover an opening in the chamber; and
a heat sink substantially surrounding sidewalls of the chamber.

14. The thermometer of claim 1, wherein the memory comprises at least one core temperature curve and wherein the thermometer is configured to calculate the core body temperature responsive to the core temperature curve and the surface temperature of the object.

15. A method of generating a temperature reading, comprising:
receiving an actuation signal on a thermometer, the thermometer disposed in proximity to a surface of an object;
detecting a sensor temperature in the thermometer;
detecting an object temperature of the surface of the object;
detecting an ambient temperature;
determining a mode of operation of the thermometer; and
displaying an output temperature dependent on the mode of operation and responsive to at least one of the sensor temperature, the object temperature, and the ambient temperature; and
storing the output temperature in a memory, the memory comprising a plurality of stored temperature readings.

16. The method of claim 15, wherein determining the mode of operation includes determining at least one of a surface mode, a body mode, and an ambient mode.

17. The method of claim 15, further comprising calculating a core body temperature responsive to the object temperature and a core temperature curve, wherein the output temperature comprises the core body temperature.

18. The method of claim 15, further comprising:
receiving a memory request from a user of the thermometer; and
displaying at least one of the stored temperature readings responsive to the memory request.

19. The method of claim 15, further comprising outputting the output temperature through a speaker in a selected language.

20. The method of claim 19, further comprising receiving a selection of the selected language from a user, wherein the selected language comprises one of a plurality of available languages.

21. The method of claim 15, wherein the output temperature comprises one of the object temperature and the ambient temperature.

22. The method of claim 15, further comprising waiting a pre-determined time interval and entering a dormant mode.

23. The method of claim 15, further comprising detecting a distance from the object.

24. A non-contact thermometer comprising:
a handle having a first end and a second end, the first end offset from the second end;
a sensor disposed at the first end of the handle and configured to detect a surface temperature of an object external to the thermometer, the sensor comprising:
a housing;
a chamber disposed in the housing;
a detector disposed at a first end of the chamber;
a window disposed at a second end of the chamber so as to cover an opening in the chamber, wherein the window is substantially transparent to infrared radiation; and
a heat sink substantially surrounding sidewalls of the chamber;
a memory configured to store prior temperature readings;
an interface disposed on the handle, the interface including:
an actuator;
a mode button configured to select at least one of a plurality of modes of operation of the non-contact thermometer; and
a memory button configured to select at least one of a plurality of stored temperature readings in the memory;
a speaker disposed in the handle, wherein the non-contact thermometer is configured to output words through the speaker in a pre-selected language; and
a display disposed on the handle, wherein the display is configured to display at least one of the surface temperature of the object, an ambient temperature, a core body temperature of the object, and a distance from the object.

25. The non-contact thermometer of claim 24, wherein the plurality of modes of operation includes at least one of a surface mode, a human body mode, an animal body mode, and an ambient mode.

26. The non-contact thermometer of claim 24, wherein the interface further comprises a language selector configured to set at least one of a plurality of languages as the pre-selected language.

27. The non-contact thermometer of claim 24, wherein the memory comprises at least one core temperature curve and wherein the non-contact thermometer is configured to calculate the core body temperature responsive to the core temperature curve and the surface temperature of the object.

28. The non-contact thermometer of claim 24, wherein the display comprises a backlight and the display is configured to change color responsive to the core body temperature of the object.

29. The non-contact thermometer of claim 24, wherein the core body temperature of the object comprises at least one of an oral temperature, a rectal temperature, an axillary temperature, and a core temperature.
